(19) United States
(12) Patent Application Publication
(10) Pub. No.: US 2019/0047578 A1
(43) Pub. Date: Feb. 14, 2019

(54) METHODS AND APPARATUS FOR DETECTING EMERGENCY EVENTS BASED ON VEHICLE OCCUPANT BEHAVIOR DATA

(71) Applicant: Intel Corporation, Santa Clara, CA (US)

(72) Inventors: Johanna Swan, Scottsdale, AZ (US); Shahrnaz Azizi, Cupertino, CA (US); Rajashree Baskaran, Portland, OR (US); Melissa Ortiz, San Jose, CA (US); Fatema Adenwala, Hillsboro, OR (US); Mengjie Yu, Folsom, CA (US)

(21) Appl. No.: 16/146,787

(22) Filed: Sep. 28, 2018

(51) Int. Cl. B60W 50/00; G06K 9/00; G08B 25/00; H04W 4/40; H04W 4/90

(52) U.S. Cl. CPC B60W 50/0098; G06K 9/00845; G08B 25/006; B60W 2540/28; H04W 4/90; B60W 2540/02; H04W 4/40

(57) ABSTRACT

Methods and apparatus for detecting and/or predicting emergency events based on vehicle occupant behavior data are disclosed. An apparatus includes at least one of a camera and an audio sensor, and further includes an event detector, a notification generator, and a radio transmitter. The camera is to capture image data associated with an occupant inside of a vehicle. The audio sensor is to capture audio data associated with the occupant inside of the vehicle. The event detector is to at least one of predict or detect an emergency event based on the at least one of the image data and the audio data. The notification generator is to generate notification data in response to an output of the event detector. The radio transmitter is to transmit the notification data.

### FIELD OF THE DISCLOSURE

This disclosure relates generally to methods and apparatus for detecting emergency events and, more specifically, to methods and apparatus for detecting emergency events based on vehicle occupant behavior data.

### BACKGROUND

Some modern vehicles are equipped with accident (e.g., crash) detection systems having automated accident detection capabilities. Some such known accident detection systems further include automated accident reporting capabilities. Some modern vehicles are additionally or alternatively equipped with speech recognition systems that enable an occupant of the vehicle to command one or more operation(s) of the vehicle in response to the speech recognition system determining that certain words and/or phrases corresponding to the command have been spoken by the occupant. As used herein, the term “occupant” means a driver and/or passenger. For example, the phrase “occupant of a vehicle” means a driver and/or passenger of the vehicle.

### BRIEF DESCRIPTION OF THE DRAWINGS

FIG. 1 illustrates an example environment of use in which an example emergency detection apparatus associated with an example vehicle detects and/or predicts emergency events based on vehicle occupant behavior data.

FIG. 2 is a block diagram of the example emergency detection apparatus of FIG. 1 constructed in accordance with teachings of this disclosure.

FIG. 3 is a flowchart representative of example machine readable instructions that may be executed to implement the example emergency detection apparatus of FIGS. 1 and/or 2 to detect and/or predict emergency events based on vehicle occupant behavior data.

FIG. 4 is a flowchart representative of example machine readable instructions that may be executed to implement the example emergency detection apparatus of FIGS. 1 and/or 2 to analyze image data and audio data to detect and/or predict emergency events.

FIG. 5 is an example processor platform capable of executing the example instructions of FIGS. 3 and/or 4 to implement the example emergency detection apparatus of FIGS. 1 and/or 2.

Certain examples are shown in the above-identified figures and described in detail below. In describing these examples, identical reference numbers are used to identify the same or similar elements. The figures are not necessarily to scale and certain features and certain views of the figures may be shown exaggerated in scale or in schematic for clarity and/or conciseness.

### DETAILED DESCRIPTION

Some modern vehicles are equipped with accident (e.g., crash) detection systems having automated accident detection capabilities. The automated accident detection capabilities of such known systems depend on one or more vehicle-implemented sensor(s) (e.g., an airbag sensor, a tire pressure sensor, a wheel speed sensor, etc.) detecting and/or sensing data indicating that the vehicle has been involved in an accident. In some instances, such known accident detection systems may further include automated accident reporting capabilities that cause the accident detection system and/or, more generally, the vehicle to initiate contact with (e.g., initiate a telephone call to) an emergency authority (e.g., an entity responsible for dispatching an emergency service) or a third party service who can contact such an authority in response to the automated detection of the accident.

The known accident detection systems described above have several disadvantages. For example, such known accident detection systems are not capable of automatically detecting non-accident emergency events relating to the vehicle (e.g., a theft of the vehicle), or emergency events relating specifically to the occupant(s) of the vehicle (e.g., a medical impairment of an occupant of the vehicle, a kidnapping or assault of an occupant of the vehicle, etc.). As another example, such known accident detection systems do not operate based on predictive elements (e.g., artificial intelligence), and are therefore unable to automatically report an accident involving the vehicle to an emergency authority (or a third party service who can contact such an authority) until after the accident has already occurred.

Some modern vehicles are additionally or alternatively equipped with speech recognition systems that enable an occupant of the vehicle to command one or more operation(s) of the vehicle in response to the speech recognition system determining that certain words and/or phrases corresponding to the command have been spoken by the occupant. For example, the speech recognition system may cause the vehicle to initiate a telephone call to an individual named John Smith in response to determining that the phrase “call John Smith” has been spoken by an occupant of the vehicle. In some instances, such known speech recognition systems may be utilized by an occupant of the vehicle to initiate contact with an emergency authority or a third party service who can contact such an authority. For example, an occupant of the vehicle may determine that the vehicle and/or one or more occupant(s) of the vehicle has/have experienced an emergency event (e.g., an accident involving the vehicle, a medical impairment of an occupant of the vehicle, a kidnapping or assault of an occupant of the vehicle, etc.). In response to making such a determination, the occupant of the vehicle may speak the phrase “call 9-1-1” with the intent of commanding the vehicle to initiate contact with a 9-1-1 emergency authority. In response to determining that the phrase “call 9-1-1” has been spoken by the occupant of the vehicle, the speech recognition system may initiate contact with the 9-1-1 emergency authority; perhaps after confirming the action is desired to avoid accidental calls.

The known speech recognition systems described above also have several disadvantages. For example, such known speech recognition systems can only initiate contact with an emergency authority or a third party emergency support service in response to an occupant of the vehicle speaking certain words and/or phrases to invoke the speech recognition system to initiate such contact. Some such speech recognition systems are only engaged if an occupant of the vehicle presses a button. If the occupant of the vehicle becomes impaired and/or incapacitated prior to invoking the speech recognition system to initiate contact with the emergency authority or a third party emergency support service, the ability to initiate such contact is lost. As another example, such known speech recognition systems do not operate based on predictive elements (e.g., artificial intelligence), and are therefore unable to automatically report an emergency event involving the vehicle and/or the occupant(s) of the vehicle to an emergency authority or a third party emergency support service until after the event has occurred and the system has been specifically commanded to do so by an occupant of the vehicle. An occupant of the vehicle would typically first issue such a command to the speech recognition system at a time after the emergency event has already occurred. As another example, the initiating communication sent from the vehicle to the emergency authority or the third party emergency support service does not include data indicating the type and/or nature of the emergency event that has occurred.

Unlike the known accident detection systems and speech recognition systems described above, methods and apparatus disclosed herein advantageously implement an artificial intelligence framework to automatically detect and/or predict one or more emergency event(s) in real time (or near real time) based on behavior data associated with one or more occupant(s) of a vehicle. In some disclosed example methods and apparatus, one or more camera(s) capture image data associated with the one or more occupant(s) of the vehicle. In some such examples, an emergency event may be automatically detected and/or predicted based on one or more movement(s) of the occupant(s), with such movement(s) being identified by the artificial intelligence framework in real time (or near real time) in association with an analysis of the captured image data. In some disclosed examples, one or more audio sensor(s) capture audio data associated with the one or more occupant(s) of the vehicle. In some such examples, an emergency event may be automatically detected and/or predicted based on one or more vocalization(s) of the occupant(s), with such vocalization(s) being identified by the artificial intelligence framework in real time (or near real time) in association with an analysis of the captured audio data.

In response to automatically detecting and/or predicting an emergency event, example methods and apparatus disclosed herein automatically generate a notification of the emergency event, and automatically transmit the generated notification to an emergency authority or a third party service supporting contact to such an authority. In some examples, the notification may include location data identifying the location of the vehicle. In some examples, the notification may further include event type data identifying the type of emergency that occurred, is about to occur, and/or is occurring. In some examples, the notification may further include vehicle identification data identifying the vehicle. In some examples, the notification may further include occupant identification data identifying the occupant(s) of the vehicle.

As a result of the automated emergency event detection and/or prediction being performed in real time (or near real time) via an artificial intelligence framework as disclosed herein, automated notification generation and notification transmission capabilities disclosed herein can advantageously be implemented and/or executed as an emergency event is still developing (e.g., prior to the event occurring) and/or while the emergency event is occurring. Accordingly, example methods and apparatus disclosed herein can advantageously notify an emergency authority (or a third party service supporting contact to such an authority) of an emergency event in real time (or near real time) before and/or while it is occurring, as opposed to after the emergency event has already occurred.

Some example methods and apparatus disclosed herein may additionally or alternatively automatically transmit the generated notification to one or more subscriber device(s) which may be associated with one or more other vehicle(s). In some examples, one or more of the notified other vehicle(s) may be located at a distance from the vehicle associated with the emergency event that is less than a distance between the notified emergency authority and the vehicle. In such examples, one or more of the notified other vehicle(s) may be able to reach the vehicle more quickly than would be the case for an emergency vehicle dispatched by the notified emergency authority. One or more of the notified other vehicle(s) may accordingly be able to assist in resolving the emergency event (e.g., administering cardiopulmonary resuscitation or other medical assistance, tracking a vehicle or an individual traveling with a kidnapped child, etc.) before the dispatched emergency vehicle is able to arrive at the location of the emergency event and take over control of the scene. Subscribers using and/or associated with the one or more subscriber device(s) may include, for example, any number of family members, friends, co-workers, third party services, etc.

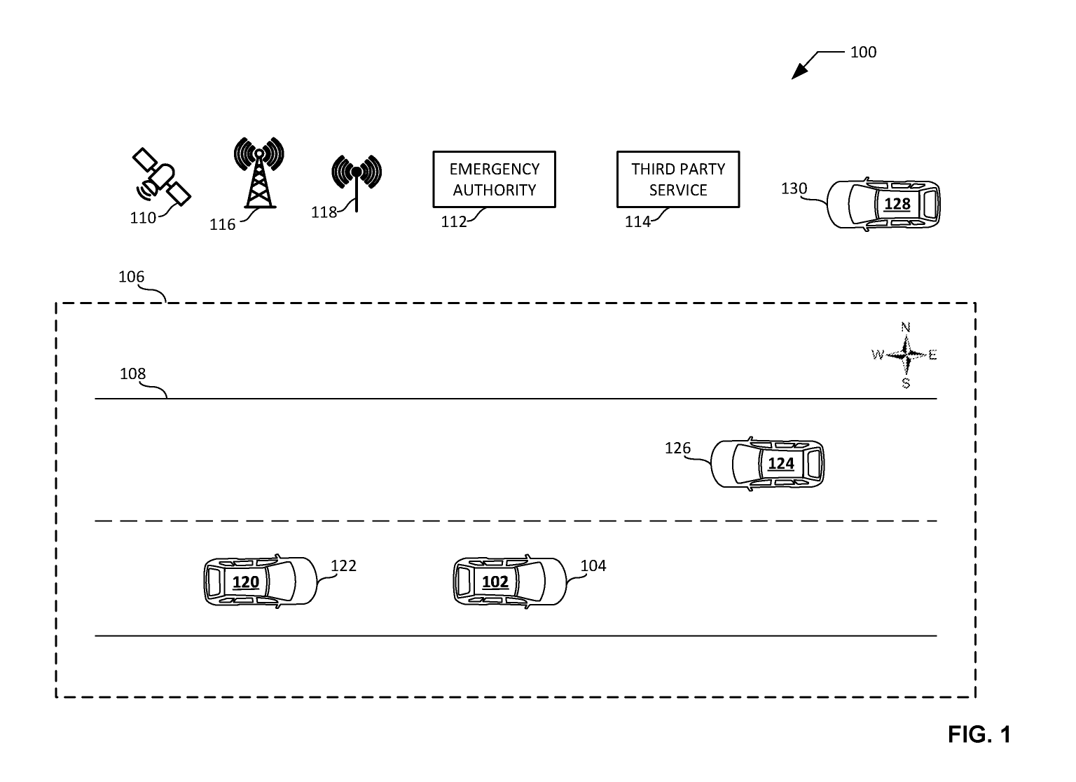

FIG. 1 illustrates an example environment of use 100 in which an example emergency detection apparatus 102 associated with an example vehicle 104 detects and/or predicts emergency events based on vehicle occupant behavior data. In some examples, the emergency detection apparatus 102 of FIG. 1 may be an in-vehicle apparatus that is integral to the vehicle 104 of FIG. 1. In other examples, the emergency detection apparatus 102 of FIG. 1 may be implemented as a mobile device that can be removably located and/or positioned within the vehicle 104 of FIG. 1 (e.g., an occupant's mobile phone). The vehicle 104 of FIG. 1 may be implemented as any type of vehicle (e.g., a car, a truck, a sport utility vehicle, a van, a bus, a motorcycle, a train, an aircraft, a watercraft, etc.) configured to be occupied by one or more occupant(s) (e.g., one or more human(s) including, for example, a driver and/or one or more passenger(s)). The emergency detection apparatus 102 of FIG. 1 may function and/or operate regardless of whether an engine of the vehicle 104 of FIG. 1 is running, and regardless of whether the vehicle 104 of FIG. 1 is moving. The vehicle 104 may be manually operated, autonomous, or partly autonomous and partly manually operated.

In the illustrated example of FIG. 1, the environment of use 100 includes an example geographic area 106 through and/or within which the vehicle 104 including the emergency detection apparatus 102 may travel and/or be located. The geographic area 106 of FIG. 1 may be of any size and/or shape. In the illustrated example of FIG. 1, the geographic area 106 includes an example road 108 over and/or on which the vehicle 104 including the emergency detection apparatus 102 may travel and/or be located. In other examples, the geographic area 106 may include a different number of roads (e.g., 0, 10, 100, 1000, etc.). The geographic area 106 is not meant as a restriction on where the vehicle may travel. Instead, it is an abstraction to illustrate an area in proximity to the vehicle. The geographic area 106 may have any size, depending on implementation details.

The emergency detection apparatus 102 of FIG. 1 includes one or more camera(s) located and/or positioned within the vehicle 104 of FIG. 1. The camera(s) of the emergency detection apparatus 102 of this example capture(s) image data associated with one or more occupant(s) of the vehicle 104. For example, the camera(s) of the emergency detection apparatus 102 of FIG. 1 may capture image data associated with one or more physical behavior(s) (e.g., movement(s)) of the occupant(s) of the vehicle 104 of FIG. 1. The emergency detection apparatus 102 of FIG. 1 also includes one or more audio sensor(s) located and/or positioned within the vehicle 104 of FIG. 1. The audio sensor(s) of the emergency detection apparatus 102 of this example capture(s) audio data associated with one or more occupant(s) of the vehicle 104. For example, the audio sensor(s) of the emergency detection apparatus 102 of FIG. 1 may capture audio data associated with one or more audible behavior(s) (e.g., vocalization(s)) of the occupant(s) of the vehicle 104 of FIG. 1.

The emergency detection apparatus 102 of FIG. 1 also includes an event detector to detect and/or predict an emergency event based on the captured image data and/or the captured audio data. For example, the event detector of the emergency detection apparatus 102 of FIG. 1 may detect and/or predict an accident (or imminent/potential accident) involving the vehicle 104, a medical impairment (or imminent/potential impairment) of an occupant of the vehicle 104, a kidnapping and/or assault (or imminent/potential kidnapping or assault) of an occupant of the vehicle 104, etc. based on the captured image data and/or the captured audio data.

The emergency detection apparatus 102 of FIG. 1 also includes a GPS receiver to receive location data via example GPS satellites 110. The emergency detection apparatus 102 of FIG. 1 also includes a vehicle identifier to determine vehicle identification data associated with the vehicle 104. The emergency detection apparatus 102 of this example also includes an occupant identifier to determine occupant identification data associated with the occupant(s) of the vehicle 104. In some examples, the emergency detection apparatus 102 may associate the location data, the vehicle identification data, and/or the occupant identification data with a detected and/or predicted emergency event.

The emergency detection apparatus 102 of FIG. 1 also includes radio circuitry to transmit a notification associated with the detected and/or predicted emergency event over a network (e.g., a cellular network, a wireless local area network, etc.) to an example emergency authority 112 (e.g., a remote server) responsible for dispatching one or more emergency service(s) (e.g., police, fire, medical, etc.), or to an example third party service 114 (e.g., a remote server) capable of contacting such an authority (e.g., OnStar®). In the illustrated example of FIG. 1, the emergency detection apparatus 102 may transmit the notification of the detected and/or predicted emergency event to the emergency authority 112 and/or to the third party service 114 via an example cellular base station 116 or via an example wireless access point 118. The environment of use 100 may include any number of emergency authorities and/or third party services, and the emergency detection apparatus 102 of FIG. 1 may transmit the notification to any or all of such emergency authorities and/or third party services. The transmitted notification may include data and/or information associated with the detected and/or predicted emergency event. For example, the transmitted notification may include data and/or information identifying the type and/or nature of the detected and/or predicted emergency event, the location data associated with the vehicle 104, the vehicle identification data associated with the vehicle 104, and/or the occupant identification data associated with the vehicle 104.

In some examples, the emergency detection apparatus 102 of FIG. 1 may additionally or alternatively transmit the notification to one or more subscriber machine(s) which may be associated with one or more other vehicle(s). For example, the environment of use 100 of FIG. 1 includes an example first subscriber machine 120 associated with an example first other vehicle 122, an example second subscriber machine 124 associated with an example second other vehicle 126, and an example third subscriber machine 128 associated with an example third other vehicle 130. In the illustrated example of FIG. 1, the first other vehicle 122 is located within the geographic area 106 and is trailing the vehicle 104 on the road 108, the second other vehicle 126 is located within the geographic area 106 and is approaching the vehicle 104 on the road 108, and the third other vehicle 130 is located outside of the geographic area 106. The emergency detection apparatus 102 of FIG. 1 may transmit the notification to any or all of the first subscriber machine 120 associated with the first other vehicle 122, the second subscriber machine 124 associated with the second other vehicle 126, and/or the third subscriber machine 128 associated with the third other vehicle 130. The environment of use 100 may include any number of subscriber machines which may be associated with any number of other vehicles, and the emergency detection apparatus 102 of FIG. 1 may transmit the notification to any or all of such subscriber machines.

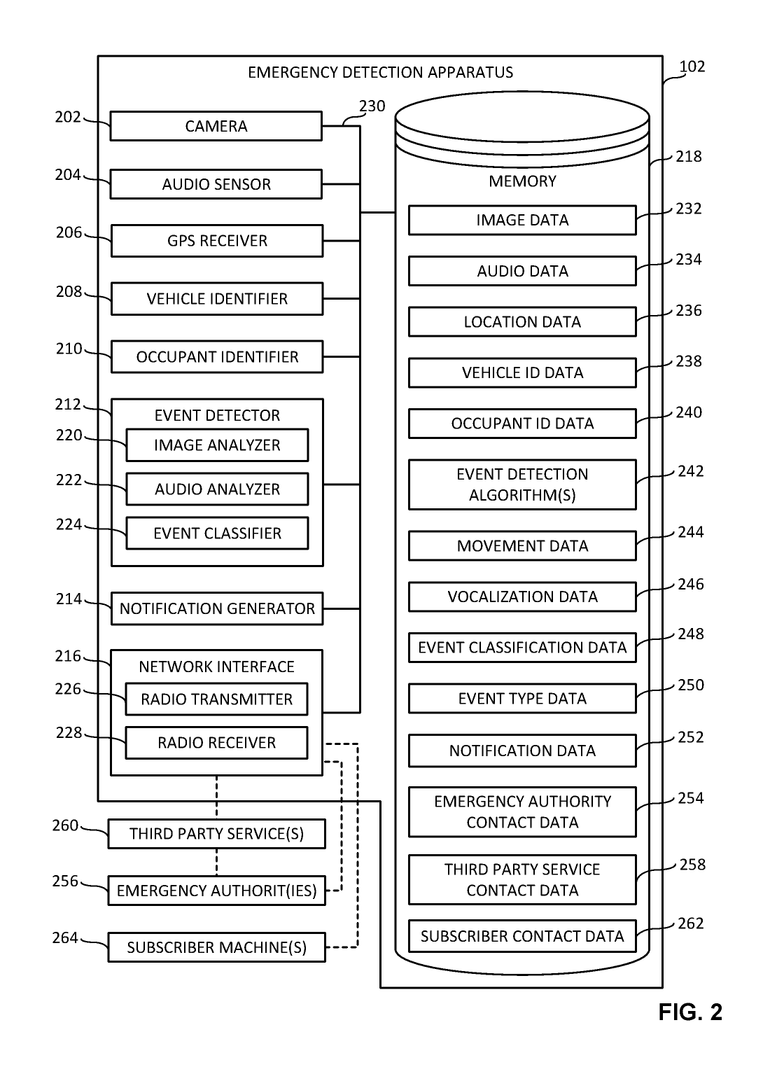

FIG. 2 is a block diagram of an example implementation of the example emergency detection apparatus 102 of FIG. 1 constructed in accordance with teachings of this disclosure. In the illustrated example of FIG. 2, the emergency detection apparatus 102 includes an example camera 202, an example audio sensor 204, an example GPS receiver 206, an example vehicle identifier 208, an example occupant identifier 210, an example event detector 212, an example notification generator 214, an example network interface 216, and an example memory 218. The example event detector 212 of FIG. 2 includes an example image analyzer 220, an example audio analyzer 222, and an example event classifier 224. The example network interface 216 of FIG. 2 includes an example radio transmitter 226 and an example radio receiver 228. However, other example implementations of the emergency detection apparatus 102 may include fewer or additional structures.

In the illustrated example of FIG. 2, the camera 202, the audio sensor 204, the GPS receiver 206, the vehicle identifier 208, the occupant identifier 210, the event detector 212 (e.g., including the image analyzer 220, the audio analyzer 222, and the event classifier 224), the notification generator 214, the network interface 216 (e.g., including the radio transmitter 226 and the radio receiver 228), and/or the memory 218 are operatively coupled (e.g., in electrical communication) via an example communication bus 230. In some examples, the communication bus 230 of the emergency detection apparatus 102 may be implemented as a controller area network (CAN) bus of the vehicle 104 of FIG. 1.

The example camera 202 of FIG. 2 is pointed toward the interior and/or cabin (e.g., passenger and/or driver section) of the vehicle 104 to capture images and/or videos including, for example, images and/or videos of one or more occupant(s) located within the vehicle 104 of FIG. 1. In some examples, the camera 202 may be implemented as a single camera configured and/or positioned to capture images and/or videos of the occupant(s) of the vehicle 104. In other examples, the camera 202 may be implemented as a plurality of cameras (e.g., an array of cameras) that are collectively configured to capture images and/or videos of the occupant(s) of the vehicle 104. Example image data 232 captured by the camera 202 may be associated with one or more local time(s) (e.g., time stamped) at which the data was captured by the camera 202. The image data 232 captured by the camera 202 may be of any quantity, type, form and/or format, and may be stored in a computer-readable storage medium such as the example memory 218 of FIG. 2 described below.

The example audio sensor 204 of FIG. 2 is positioned to capture audio within the interior and/or cabin of the vehicle 104 including, for example, audio generated by one or more occupant(s) located within the vehicle 104 of FIG. 1. In some examples, the audio sensor 204 may be implemented as a single microphone configured and/or positioned to capture audio generated by the occupant(s) of the vehicle 104. In other examples, the audio sensor 204 may be implemented as a plurality of microphones (e.g., an array of microphones) that are collectively configured to capture audio generated by the occupant(s) of the vehicle 104. Example audio data 234 captured by the audio sensor 204 may be associated with one or more local time(s) (e.g., time stamped) at which the data was captured by the audio sensor 204. In some examples, a local clock is used to timestamp the image data 232 and the audio data 234 to maintain synchronization between the same. The audio data 234 captured by the audio sensor 204 may be of any quantity, type, form and/or format, and may be stored in a computer-readable storage medium such as the example memory 218 of FIG. 2 described below.

The example GPS receiver 206 of FIG. 2 collects, acquires and/or receives data and/or one or more signal(s) from one or more GPS satellite(s) (e.g., represented by the GPS satellite 110 of FIG. 1). Typically, signals from three or more satellites are needed to form the GPS triangulation to identify the location of the vehicle 104. The data and/or signal(s) received by the GPS receiver 206 may include information (e.g., time stamps) from which the current position and/or location of the emergency detection apparatus 102 and/or the vehicle 104 of FIGS. 1 and/or 2 may be identified and/or derived, including for example, the current latitude and longitude of the emergency detection apparatus 102 and/or the vehicle 104. Example location data 236 identified and/or derived from the signal(s) collected and/or received by the GPS receiver 206 may be associated with one or more local time(s) (e.g., time stamped) at which the data and/or signal(s) were collected and/or received by the GPS receiver 206. In some examples, a local clock is used to timestamp the image data 232, the audio data 234 and the location data 236 to maintain synchronization between the same. The location data 236 identified and/or derived from the signal(s) collected and/or received by the GPS receiver 206 may be of any quantity, type, form and/or format, and may be stored in a computer-readable storage medium such as the example memory 218 of FIG. 2 described below.

The example vehicle identifier 208 of FIG. 2 detects, identifies and/or determines data corresponding to an identity of the vehicle 104 of FIG. 1 (e.g., vehicle identification data). For example, the vehicle identifier 208 may detect, identify and/or determine one or more of a vehicle identification number (VIN), a license plate number (LPN), a make, a model, a color, etc. of the vehicle 104. The vehicle identifier 208 of FIG. 2 may be implemented by any type(s) and/or any number(s) of semiconductor device(s) (e.g., microprocessor(s), microcontroller(s), etc.). Example vehicle identification data 238 detected, identified and/or determined by the vehicle identifier 208 may be of any quantity, type, form and/or format, and may be stored in a computer-readable storage medium such as the example memory 218 of FIG. 2 described below.

In some examples, the vehicle identifier 208 may detect, identify and/or determine the vehicle identification data 238 based on preprogrammed vehicle identification data that is stored in the memory 218 of the emergency detection apparatus 102 and/or in a memory of the vehicle 104. In such examples, the vehicle identifier 208 may detect, identity and/or determine the vehicle identification data 238 by accessing the preprogrammed vehicle identification data from the memory 218 and/or from a memory of the vehicle 104.

The example occupant identifier 210 of FIG. 2 detects, identifies and/or determines data corresponding to an identity of the occupant(s) of the vehicle 104 of FIG. 1 (e.g., occupant identification data). For example, the occupant identifier 210 may detect, identify and/or determine one or more of a driver's license number (DLN), a name, an age, a sex, a race, etc. of one or more occupant(s) of the vehicle 104. The occupant identifier 210 of FIG. 2 may be implemented by any type(s) and/or any number(s) of semiconductor device(s) (e.g., microprocessor(s), microcontroller(s), etc.). Example occupant identification data 240 detected, identified and/or determined by the occupant identifier 210 may be of any quantity, type, form and/or format, and may be stored in a computer-readable storage medium such as the example memory 218 of FIG. 2 described below.

In some examples, the occupant identifier 210 may detect, identify and/or determine the occupant identification data 240 based on preprogrammed occupant identification data that is stored in the memory 218 of the emergency detection apparatus 102 and/or in a memory of the vehicle 104. In such examples, the occupant identifier 210 may detect, identity and/or determine the occupant identification data 240 by accessing the preprogrammed occupant identification data from the memory 218 and/or from a memory of the vehicle 104. In other examples, the occupant identifier 210 may detect, identify and/or determine the occupant identification data 240 by applying (e.g., executing) one or more computer vision technique(s) (e.g., a facial recognition algorithm) to the image data 232 captured via the camera 202 of the emergency detection apparatus 102. In still other examples, the occupant identifier 210 may detect, identify and/or determine the occupant identification data 240 by applying (e.g., executing) one or more voice recognition technique(s) (e.g., a speech recognition algorithm) to the audio data 234 captured via the audio sensor 204 of the emergency detection apparatus 102. In some examples, the computer vision and/or voice recognition processes may be executed onboard the vehicle 104. In other examples, the computer vision and/or voice recognition processes may be executed by a server on the Internet (e.g., in the cloud).

The example event detector 212 of FIG. 2 implements an artificial intelligence framework that applies and/or executes one or more example event detection algorithm(s) 242 to automatically detect and/or predict emergency events in real time (or near real time) based on behavior data associated with the occupant(s) of the vehicle 104 of FIG. 1. For example, the event detector 212 of FIG. 2 may automatically detect and/or predict an emergency event based on one or more movement(s) of the occupant(s) of the vehicle. The movement(s) may be predicted, detected and/or identified by the artificial intelligence framework in real time (or near real time) based on an analysis of the image data 232 captured via the camera 202 of FIG. 2. The event detector 212 of FIG. 2 may additionally or alternatively automatically detect and/or predict an emergency event based on one or more vocalization(s) of the occupant(s) of the vehicle. The vocalization(s) may be predicted, detected and/or identified by the artificial intelligence framework in real time (or near real time) based on an analysis of the audio data 234 captured via the audio sensor 204 of FIG. 2. The event detector 212 of FIG. 2 may be implemented by any type(s) and/or any number(s) of semiconductor device(s) (e.g., microprocessor(s), microcontroller(s), etc.). In some examples, the event detector 212 may be executed onboard the vehicle 104. In other examples, the event detector 212 may be executed by a server on the Internet (e.g., in the cloud). As mentioned above, the event detector 212 of FIG. 2 includes the image analyzer 220, the audio analyzer 222, and the event classifier 224 of FIG. 2. The event detection algorithm(s) 242 to be applied and/or executed by the event detector 212 of FIG. 2 may be of any quantity, type, form and/or format, and may be stored in a computer-readable storage medium such as the example memory 218 of FIG. 2 described below.

The example image analyzer 220 of FIG. 2 analyzes the image data 232 captured via the camera 202 of FIG. 2 to detect and/or predict one or more movement(s) associated with the occupant(s) of the vehicle 104 of FIG. 1. In some examples, the image analyzer 220 may implement one or more of the event detection algorithm(s) 242 to predict, detect, identify and/or determine whether the image data 232 includes any movement(s) associated with the occupant(s) of the vehicle 104 that is/are indicative of the development or occurrence of an emergency event involving the occupant(s) and/or the vehicle 104. Such movement(s) may include, for example, the ejection or removal of an occupant from the vehicle 104, the entry of an occupant into the vehicle 104, a body position (e.g., posture, attitude, pose, hand or arm covering face, hand or arm bracing for impact, etc.) of an occupant of the vehicle 104, a facial expression of an occupant of the vehicle 104, etc.

For example, the image analyzer 220 may analyze the image data 232 for instances of forcible ejection of an occupant from the vehicle 104 due to mechanical forces, as may occur in connection with an accident involving the vehicle 104. As another example, the image analyzer 220 may analyze the image data 232 for instances of forcible removal of an occupant from the vehicle 104 at the hands of a human, as may occur in connection with a kidnapping or assault of an occupant of the vehicle 104, or in connection with a carjacking of the vehicle 104. As another example, the image analyzer 220 may analyze the image data 232 for instances of forcible entry of an occupant into the vehicle, as may occur in connection with a carjacking or a theft of the vehicle 104. As another example, the image analyzer 220 may analyze the image data 232 for instances of a body position (e.g., posture, attitude, pose, etc.) of an occupant of the vehicle 104 indicating that the occupant is becoming or has become medically injured, impaired or incapacitated (e.g., that the occupant is bleeding, has suffered a stroke or a heart attack, or has been rendered unconscious). As another example, the image analyzer 220 may analyze the image data 232 for instances of a facial expression of an occupant of the vehicle 104 indicating that the occupant is becoming or has become medically injured, impaired or incapacitated (e.g., that the occupant is bleeding, has suffered a stroke or a heart attack, or has been rendered unconscious). As another example, the image analyzer 220 may analyze the image data 232 for instances of a bracing position (e.g., hand or arm extended outwardly from body) of an occupant of the vehicle 104, a defensive position (e.g., hand or arm covering face) of an occupant of the vehicle 104, and/or a facial expression (e.g., screaming) of an occupant of the vehicle 104 to predict impending impact or other danger.

The image analyzer 220 of FIG. 2 may be implemented by any type(s) and/or any number(s) of semiconductor device(s) (e.g., microprocessor(s), microcontroller(s), etc.). In some examples, the image analyzer 220 may be executed onboard the vehicle 104. In other examples, the image analyzer 220 may be executed by a server on the Internet (e.g., in the cloud). Example movement data 244 predicted, detected, identified and/or determined by the image analyzer 220 may be associated with one or more local time(s) (e.g., time stamped) corresponding to the local time(s) at which the associated image data 232 was captured by the camera 202. The movement data 244 predicted, detected, identified and/or determined by the image analyzer 220 may be of any quantity, type, form and/or format, and may be stored in a computer-readable storage medium such as the example memory 218 of FIG. 2 described below.

The example audio analyzer 222 of FIG. 2 analyzes the audio data 234 captured via the audio sensor 204 of FIG. 2 to detect and/or predict one or more vocalization(s) associated with the occupant(s) of the vehicle 104 of FIG. 1. In some examples, the audio analyzer 222 may implement one or more of the event detection algorithm(s) 242 to predict, detect, identify and/or determine whether the audio data 234 includes any vocalization(s) associated with the occupant(s) of the vehicle 104 that is/are indicative of the development or occurrence of an emergency event involving the occupant(s) and/or the vehicle 104. Such vocalization(s) may include, for example, a pattern (e.g., a series) of words spoken by an occupant, a pattern (e.g., a series) of sounds uttered by an occupant, a speech characteristic (e.g., intonation, articulation, pronunciation, cessation, tone, pitch, rate, rhythm, etc.) associated with words spoken by an occupant, a speech characteristic (e.g., intonation, articulation, pronunciation, cessation, tone, pitch, rate, rhythm, etc.) associated with sounds uttered by an occupant, etc.

For example, the audio analyzer 222 may analyze the audio data 234 for instances of a pattern (e.g., a series) of words spoken by an occupant of the vehicle 104 indicating that the vehicle is becoming or has become involved in an accident. As another example, the audio analyzer 222 may analyze the audio data 234 for instances of a pattern (e.g., a series) of words spoken by an occupant of the vehicle 104 indicating that the occupant is being or has been forcibly removed from the vehicle 104, as may occur in connection with a kidnapping or assault of an occupant of the vehicle 104, or in connection with a carjacking of the vehicle 104. As another example, the audio analyzer 222 may analyze the audio data 234 for instances of a pattern (e.g., a series) of words spoken by an occupant of the vehicle 104 indicating that an occupant is forcibly entering or has forcibly entered the vehicle 104, as may occur in connection with a carjacking or a theft of the vehicle 104. As another example, the audio analyzer 222 may analyze the audio data 234 for instances of a pattern (e.g., a series) of words spoken by an occupant of the vehicle 104 indicating that the occupant is becoming or has become medically injured, impaired or incapacitated (e.g., that the occupant is bleeding, has suffered a stroke or a heart attack, or has been rendered unconscious). The audio analyzer 222 may additionally or alternatively conduct the aforementioned example analyses of the audio data 234 in relation to a pattern (e.g., a series) of sounds (e.g., screaming) uttered by an occupant, a speech characteristic (e.g., intonation, articulation, pronunciation, cessation, tone, pitch, rate, rhythm, etc.) associated with words spoken by an occupant, and/or a speech characteristic (e.g., intonation, articulation, pronunciation, cessation, tone, pitch, rate, rhythm, etc.) associated with sounds uttered by an occupant.

The audio analyzer 222 of FIG. 2 may be implemented by any type(s) and/or any number(s) of semiconductor device(s) (e.g., microprocessor(s), microcontroller(s), etc.). In some examples, the audio analyzer 222 may be executed onboard the vehicle 104. In other examples, the audio analyzer 222 may be executed by a server on the Internet (e.g., in the cloud). Example vocalization data 246 predicted, detected, identified and/or determined by the audio analyzer 222 may be associated with one or more local time(s) (e.g., time stamped) corresponding to the local time(s) at which the associated audio data 234 was captured by the audio sensor 204. The vocalization data 246 predicted, detected, identified and/or determined by the audio analyzer 222 may be of any quantity, type, form and/or format, and may be stored in a computer-readable storage medium such as the example memory 218 of FIG. 2 described below.

In some examples, the event detector 212 of FIG. 2 may detect and/or predict an emergency event based only on the movement data 244 predicted, detected, identified and/or determined by the image analyzer 220 of FIG. 2 in relation to the image data 232 captured via the camera 202 of FIG. 2. In other examples, the event detector 212 of FIG. 2 may detect and/or predict an emergency event based only on the vocalization data 246 predicted, detected, identified and/or determined by the audio analyzer 222 of FIG. 2 in relation to the audio data 234 captured via the audio sensor 204 of FIG. 2. In still other examples the event detector 212 of FIG. 2 may detect and/or predict an emergency event based on the movement data 244 predicted, detected, identified and/or determined by the image analyzer 220 of FIG. 2 in relation to the image data 232 captured via the camera 202 of FIG. 2, and further based on the vocalization data 246 predicted, detected, identified and/or determined by the audio analyzer 222 of FIG. 2 in relation to the audio data 234 captured via the audio sensor 204 of FIG. 2.

The example event classifier 224 of FIG. 2 predicts, detects, identifies and/or determines an event type corresponding to the emergency event detected and/or predicted by the event detector 212 of FIG. 2. In some examples, the event classifier 224 may implement one or more of the event detection algorithm(s) 242 to predict, detect, identify and/or determine whether the movement data 244 and/or the vocalization data 246 associated with the detected and/or predicted emergency event is/are indicative of one or more event type(s) from among a library or database of classified emergency events.

For example, the event classifier 224 of FIG. 2 may compare the movement data 244 and/or the vocalization data 246 associated with the detected and/or predicted emergency event to example event classification data 248 that includes and/or is indicative of different types of classified emergency events. In some examples, the event classification data 248 may include categories that identify different classes or natures of an emergency event (e.g., a vehicle accident, a crime committed against an occupant and/or a vehicle, a medical impairment involving an occupant, a medical incapacitation involving an occupant, etc.). In other examples, the event classification data 248 may additionally or alternatively include categories that identify different classes or natures of emergency assistance needed in relation to an emergency event (e.g., assistance from a police service, assistance from a fire service, assistance from a medical service, immediate emergency response from one or more emergency authorit(ies), standby emergency response from one or more mergency authorit(ies), etc.). If the comparison performed by the event classifier 224 of FIG. 2 results in one or more matches in relation to the event classification data 248, the event classifier 224 identifies the matching event type(s) as example event type data 250, and assigns or otherwise associates the matching event type(s) and/or the event type data 250 to or with the detected and/or predicted emergency event.

The event classifier 224 of FIG. 2 may be implemented by any type(s) and/or any number(s) of semiconductor device(s) (e.g., microprocessor(s), microcontroller(s), etc.). In some examples, the event classifier 224 may be executed onboard the vehicle 104. In other examples, the event classifier 224 may be executed by a server on the Internet (e.g., in the cloud). The event type data 250 predicted, detected, identified and/or determined by the event classifier 224 may be associated with one or more local time(s) (e.g., time stamped) corresponding to the local time(s) at which the associated image data 232 was captured by the camera 202, or at which the associated audio data 234 was captured by the audio sensor 204. The event type data 250 predicted, detected, identified and/or determined by the event classifier 224 may be of any quantity, type, form and/or format, and may be stored in a computer-readable storage medium such as the example memory 218 of FIG. 2 described below.

In some examples, the movement data 244, the vocalization data 246 and/or the event classification data 248 analyzed by the event classifier 224 and/or, more generally, by the event detector 212 may include and/or may be implemented via training data. In some such examples, the training data may be updated intelligently by the event classifier 224 and/or, more generally, by the event detector 212 based on one or more machine and/or deep learning processes that are user and/or situation aware. In some such examples, the training data and/or the machine/deep learning processes may reduce (e.g., minimize) the likelihood of the event detector 212 incorrectly (e.g., falsely) detecting and/or predicting an emergency event.

The example notification generator 214 of FIG. 2 automatically generates example notification data 252 in response to detection and/or prediction of an emergency event by the event detector 212 of FIG. 2. The notification generator 214 of FIG. 2 may be implemented by any type(s) and/or any number(s) of semiconductor device(s) (e.g., microprocessor(s), microcontroller(s), etc.). In some examples, the notification generator 214 may be executed onboard the vehicle 104. In other examples, the notification generator 214 may be executed by a server on the Internet (e.g., in the cloud). In some examples, the notification data 252 generated by the notification generator 214 of FIG. 2 may include the location data 236, the vehicle identification data 238, the occupant identification data 240, and/or the event type data 250 described above. In some examples, the notification data 252 may additionally include example emergency authority contact data 254 corresponding to contact information (e.g., a phone number, an electronic address such as an Internet protocol address, etc.) associated with one or more example emergency authorit(ies) 256 (e.g., the emergency authority 112 of FIG. 1) to which the notification data 252 is to be transmitted. In some examples, the notification data 252 may additionally or alternatively include example third party service contact data 258 corresponding to contact information (e.g., a phone number, an electronic address such as an Internet protocol address, etc.) associated with one or more example third party service(s) 260 (e.g., the third party service 114 of FIG. 1) to which the notification data 252 is to be transmitted. In some examples, the notification data 252 may additionally or alternatively include example subscriber contact data 262 corresponding to contact information (e.g., a phone number, an electronic address such as an Internet protocol address, etc.) associated with one or more example subscriber machine(s) 264 (e.g., the first, second and/or third subscriber machine(s) 120, 124, 128 of FIG. 1) to which the notification data 252 is to be transmitted. The notification data 252 generated by the notification generator 214 may be of any quantity, type, form and/or format, and may be stored in a computer-readable storage medium such as the example memory 218 of FIG. 2 described below.

The example network interface 216 of FIG. 2 controls and/or facilitates one or more network-based communication(s) (e.g., cellular communication(s), wireless local area network communication(s), etc.) between the emergency detection apparatus 102 of FIGS. 1 and/or 2 and one or more of the emergency authorit(ies) 256 of FIG. 2, between the emergency detection apparatus 102 of FIGS. 1 and/or 2 and one or more of the third party service(s) 260 of FIG. 2, and/or between the emergency detection apparatus 102 of FIGS. 1 and/or 2 and one or more of the subscriber machine(s) 264 of FIG. 2. As mentioned above, the network interface 216 of FIG. 2 includes the radio transmitter 226 of FIG. 2 and the radio receiver 228 of FIG. 2.

The example radio transmitter 226 of FIG. 2 transmits data and/or one or more radio frequency signal(s) to other devices (e.g., the emergency authorit(ies) 256 of FIG. 2, the third party service(s) 260 of FIG. 2, the subscriber machine(s) 264 of FIG. 2, etc.). In some examples, the data and/or signal(s) transmitted by the radio transmitter 226 is/are communicated over a network (e.g., a cellular network and/or a wireless local area network) via the example cellular base station 116 and/or via the example wireless access point 118 of FIG. 1. In some examples, the radio transmitter 226 may automatically transmit the example notification data 252 described above in response to the generation of the notification data 252. In other examples, the occupant(s) of the vehicle 104 are given an opportunity to stop the transmission with an alert (e.g., an audible message indicating that one or more of the emergency authorit(ies) 256, one or more of the third party service(s) 260, and/or one or more of the subscriber machine(s) 264 will be alerted in five seconds unless the occupant says “stop transmission”). Data corresponding to the signal(s) to be transmitted by the radio transmitter 226 may be of any quantity, type, form and/or format, and may be stored in a computer-readable storage medium such as the example memory 218 of FIG. 2 described below.

The example radio receiver 228 of FIG. 2 collects, acquires and/or receives data and/or one or more radio frequency signal(s) from other devices (e.g., the emergency authorit(ies) 256 of FIG. 2, the third party service(s) 260 of FIG. 2, the subscriber machine(s) 264 of FIG. 2, etc.). In some examples, the data and/or signal(s) received by the radio receiver 228 is/are communicated over a network (e.g., a cellular network and/or a wireless local area network) via the example cellular base station 116 and/or via the example wireless access point 118 of FIG. 1. In some examples, the radio receiver 228 may receive data and/or signal(s) corresponding to one or more response, confirmation, and/or acknowledgement message(s) and/or signal(s) associated with the data and/or signal(s) (e.g., the notification data 252) transmitted by the radio transmitter 226. The response, confirmation, and/or acknowledgement message(s) and/or signal(s) may be transmitted to the radio receiver 228 from another device (e.g., one of the emergency authorit(ies) 256 of FIG. 2, one of the third party service(s) 260 of FIG. 2, one of the subscriber machine(s) 264 of FIG. 2, etc.). Data carried by, identified and/or derived from the signal(s) collected and/or received by the radio receiver 228 may be of any quantity, type, form and/or format, and may be stored in a computer-readable storage medium such as the example memory 218 of FIG. 2 described below.

The example memory 218 of FIG. 2 may be implemented by any type(s) and/or any number(s) of storage device(s) such as a storage drive, a flash memory, a read-only memory (ROM), a random-access memory (RAM), a cache and/or any other physical storage medium in which information is stored for any duration (e.g., for extended time periods, permanently, brief instances, for temporarily buffering, and/or for caching of the information). The information stored in the memory 218 may be stored in any file and/or data structure format, organization scheme, and/or arrangement.

In some examples, the memory 218 stores the image data 232 captured, obtained and/or detected by the camera 202, the audio data 234 captured, obtained and/or detected via the audio sensor 204, the location data 236 collected, received, identified and/or derived by the GPS receiver 206, the vehicle identification data 238 detected, identified and/or determined by the vehicle identifier 208, the occupant identification data 240 detected, identified and/or determined by the occupant identifier 210, the event detection algorithm(s) 242 executed by the event detector 212, the movement data 244 predicted, detected, identified and/or determined by the image analyzer 220, the vocalization data 246 predicted, detected, identified and/or determined by the audio analyzer 222, the event classification data 248 analyzed by the event classifier 224, the event type data 250 predicted, detected, identified or determined by the event classifier 224, the notification data 252 generated by the notification generator 214 and/or to be transmitted by the radio transmitter 226, the emergency authority contact data 254 to be identified by the notification generator 214, the third party service contact data 258 to be identified by the notification generator 214, and/or the subscriber contact data 262 to be identified by the notification generator 214 of FIG. 2.

The memory 218 is accessible to one or more of the example camera 202, the example audio sensor 204, the example GPS receiver 206, the example vehicle identifier 208, the example occupant identifier 210, the example event detector 212 (including the example image analyzer 220, the example audio analyzer 222, and the example event classifier 224), the example notification generator 214 and/or the example network interface 216 (including the example radio transmitter 226 and the example radio receiver 228) of FIG. 2, and/or, more generally, to the emergency detection apparatus 102 of FIGS. 1 and/or 2.

In the illustrated example of FIG. 2, the camera 202 described above is a means to capture image data associated with an occupant of a vehicle (e.g., an occupant of the vehicle 104 of FIG. 1). Other image capture means include video cameras, image sensors, etc. The audio sensor 204 of FIG. 2 described above is a means to capture audio data associated with the occupant of the vehicle. Other audio capture means include microphones, acoustic sensors, etc. The image analyzer 220 of FIG. 2 described above is a means to detect and/or predict movement data based on the image data. The audio analyzer 222 of FIG. 2 described above is a means to detect and/or predict vocalization data based on the audio data. The event detector 212 of FIG. 2 described above is a means to detect and/or predict an emergency event based on the image data, the audio data, the movement data and/or the vocalization data. The event classifier 224 of FIG. 2 described above is a means to determine event type data corresponding to the detected and/or predicted emergency event. The notification generator 214 of FIG. 2 described above is a means to generate notification data in response to the detection and/or prediction of the emergency event. The radio transmitter 226 of FIG. 2 described above is a means to transmit the notification data to an emergency authority (e.g., one or more of the emergency authorit(ies) 256 of FIG. 2), to a third party service (e.g., one or more of the third party service(s) 260 of FIG. 2), and/or to a subscriber machine (e.g., one or more of the subscriber machine(s) 264 of FIG. 2).

While an example manner of implementing the emergency detection apparatus 102 is illustrated in FIG. 2, one or more of the elements, processes and/or devices illustrated in FIG. 2 may be combined, divided, re-arranged, omitted, eliminated and/or implemented in any other way. Further, the example camera 202, the example audio sensor 204, the example GPS receiver 206, the example vehicle identifier 208, the example occupant identifier 210, the example event detector 212, the example notification generator 214, the example network interface 216, the example memory 218, the example image analyzer 220, the example audio analyzer 222, the example event classifier 224, the example radio transmitter 226, the example radio receiver 228 and/or, more generally, the example emergency detection apparatus 102 of FIG. 2 may be implemented by hardware, software, firmware and/or any combination of hardware, software and/or firmware. Thus, for example, any of the example camera 202, the example audio sensor 204, then example GPS receiver 206, the example vehicle identifier 208, the example occupant identifier 210, the example event detector 212, the example notification generator 214, the example network interface 216, the example memory 218, the example image analyzer 220, the example audio analyzer 222, the example event classifier 224, the example radio transmitter 226, the example radio receiver 228 and/or, more generally, the example emergency detection apparatus 102 of FIG. 2 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example camera 202, the example audio sensor 204, then example GPS receiver 206, the example vehicle identifier 208, the example occupant identifier 210, the example event detector 212, the example notification generator 214, the example network interface 216, the example memory 218, the example image analyzer 220, the example audio analyzer 222, the example event classifier 224, the example radio transmitter 226, and/or the example radio receiver 228 of FIG. 2 is/are hereby expressly defined to include a non-transitory computer readable storage device or storage disk such as a memory, a digital versatile disk (DVD), a compact disk (CD), a Blu-ray disk, etc. including the software and/or firmware. Further still, the example camera 202, the example audio sensor 204, then example GPS receiver 206, the example vehicle identifier 208, the example occupant identifier 210, the example event detector 212, the example notification generator 214, the example network interface 216, the example memory 218, the example image analyzer 220, the example audio analyzer 222, the event classifier 224, the example radio transmitter 226, the example radio receiver 228 and/or, more generally, the example emergency detection apparatus 102 of FIG. 2 may include one or more elements, processes and/or devices in addition to, or instead of, those illustrated in FIG. 2, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

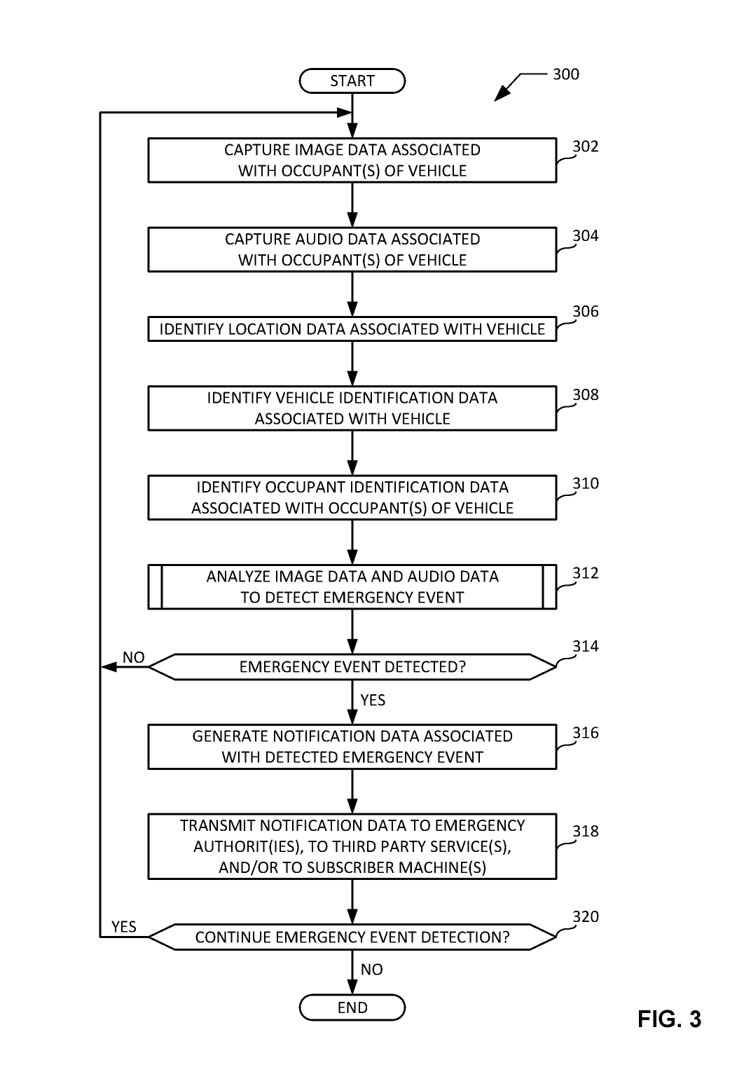

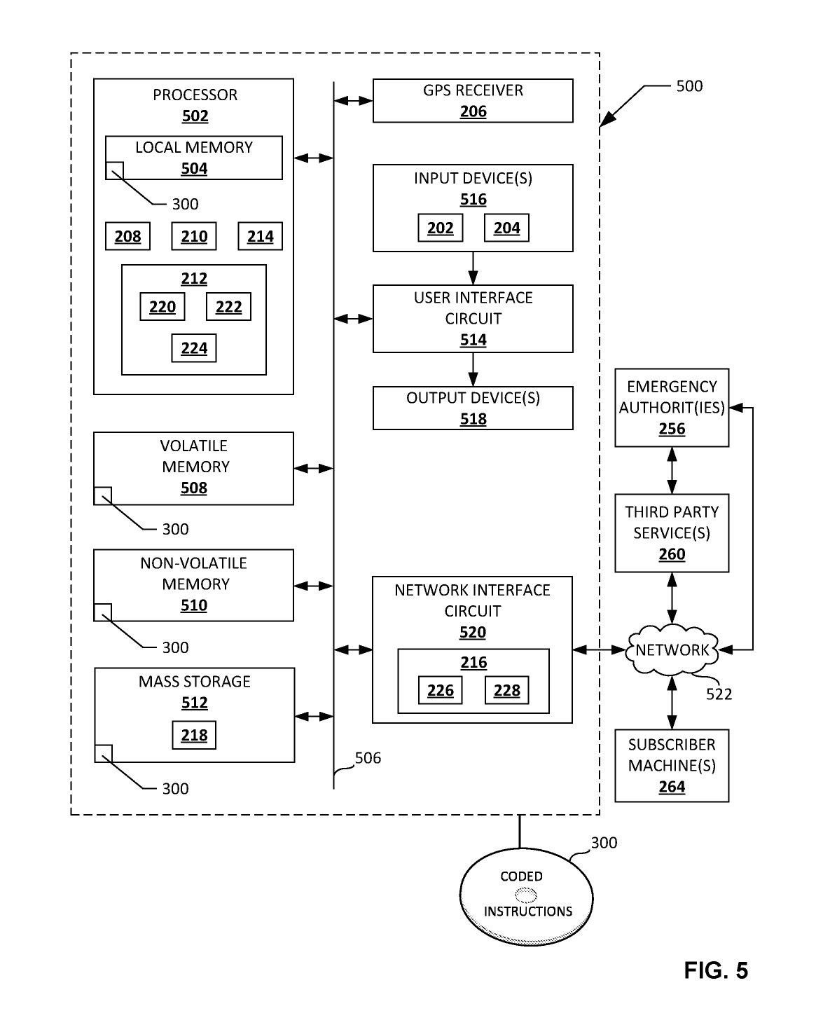

Flowcharts representative of example hardware logic, machine readable instructions, hardware implemented state machines, and/or any combination thereof for implementing the emergency detection apparatus 102 of FIGS. 1 and/or 2 are shown in FIGS. 3 and/or 4. The machine readable instructions may be one or more executable program(s) or portion(s) of executable program(s) for execution by a computer processor such as the processor 502 shown in the example processor platform 500 discussed below in connection with FIG. 5. The program(s) may be embodied in software stored on a non-transitory computer readable storage medium such as a CD-ROM, a floppy disk, a hard drive, a DVD, a Blu-ray disk, or a memory associated with the processor 502, but the entire program(s) and/or parts thereof could alternatively be executed by a device other than the processor 502 and/or embodied in firmware or dedicated hardware. Further, although the example program(s) is/are described with reference to the flowcharts illustrated in FIGS. 3 and/or 4, many other methods of implementing the example emergency detection apparatus 102 of FIGS. 1 and/or 2 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

As mentioned above, the example processes of FIGS. 3 and/or 4 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least A, (2) at least B, and (3) at least A and at least B. Similarly, as used herein in the context of describing structures, components, items, objects and/or things, the phrase “at least one of A or B” is intended to refer to implementations including any of (1) at least A, (2) at least B, and (3) at least A and at least B. As used herein in the context of describing the performance or execution of processes, instructions, actions, activities and/or steps, the phrase “at least one of A and B” is intended to refer to implementations including any of (1) at least A, (2) at least B, and (3) at least A and at least B. Similarly, as used herein in the context of describing the performance or execution of processes, instructions, actions, activities and/or steps, the phrase “at least one of A or B” is intended to refer to implementations including any of (1) at least A, (2) at least B, and (3) at least A and at least B.

FIG. 3 is a flowchart representative of example machine readable instructions 300 that may be executed to implement the example emergency detection apparatus 102 of FIGS. 1 and/or 2 to detect and/or predict emergency events based on vehicle occupant behavior data. The example program 300 begins when the example camera 202 of FIG. 2 captures image data associated with one or more occupant(s) of a vehicle (block 302). For example, the camera 202 may capture the image data 232 associated with the occupant(s) of the vehicle 104 of FIG. 1. The image data 232 captured by the camera 202 may be associated with or more local time(s) (e.g., time stamped) at which the data was captured by the camera 202. Following block 302, control of the example program 300 of FIG. 3 proceeds to block 304.

At block 304, the example audio sensor 204 of FIG. 2 captures audio data associated with the occupant(s) of the vehicle (block 304). For example, the audio sensor 204 may capture the audio data 234 associated with the occupant(s) of the vehicle 104 of FIG. 1. The audio data 234 captured by the audio sensor 204 may be associated with or more local time(s) (e.g., time stamped) at which the data was captured by the audio sensor 204. Following block 304, control of the example program 300 of FIG. 3 proceeds to block 306.

At block 306, the example GPS receiver 206 of FIG. 2 identifies location data associated with the vehicle (block 306). For example, the GPS receiver 206 may identify and/or derive the location data 236 associated with the vehicle 104 of FIG. 1 based on data and/or one or more signal(s) collected, acquired and/or received at the GPS receiver 206 from one or more GPS satellite(s) (e.g., represented by the GPS satellite 110 of FIG. 1). The location data 236 identified and/or derived from the signal(s) collected and/or received by the GPS receiver 206 may be associated with one or more local time(s) (e.g., time stamped) at which the data and/or signal(s) were collected and/or received by the GPS receiver 206. Following block 306, control of the example program 300 of FIG. 3 proceeds to block 308.

At block 308, the example vehicle identifier 208 of FIG. 2 identifies vehicle identification data associated with the vehicle (block 308). For example, the vehicle identifier 208 may identify one or more of a vehicle identification number (VIN), a license plate number (LPN), a make, a model, a color, etc. of the vehicle 104 of FIG. 1. In some examples, the vehicle identifier 208 may detect, identify and/or determine the vehicle identification data 238 based on preprogrammed vehicle identification data that is stored in the memory 218 of the emergency detection apparatus 102 and/or in a memory of the vehicle 104. In such examples, the vehicle identifier 208 may detect, identity and/or determine the vehicle identification data 238 by accessing the preprogrammed vehicle identification data from the memory 218 and/or from a memory of the vehicle 104. Following block 308, control of the example program 300 of FIG. 3 proceeds to block 310.

At block 310, the example occupant identifier 210 of FIG. 2 identifies occupant identification data associated with the occupant(s) of the vehicle (block 310). For example, the occupant identifier 210 may identify one or more of a driver's license number (DLN), a name, an age, a sex, a race, etc. of the occupant(s) of the vehicle 104 of FIG. 1. In some examples, the occupant identifier 210 may detect, identify and/or determine the occupant identification data 240 based on preprogrammed occupant identification data that is stored in the memory 218 of the emergency detection apparatus 102 and/or in a memory of the vehicle 104. In such examples, the occupant identifier 210 may detect, identity and/or determine the occupant identification data 240 by accessing the preprogrammed occupant identification data from the memory 218 and/or from a memory of the vehicle 104. In other examples, the occupant identifier 210 may detect, identify and/or determine the occupant identification data 240 by applying (e.g., executing) one or more computer vision technique(s) (e.g., a facial recognition algorithm) to the image data 232 captured via the camera 202 of the emergency detection apparatus 102. In still other examples, the occupant identifier 210 may detect, identify and/or determine the occupant identification data 240 by applying (e.g., executing) one or more voice recognition technique(s) (e.g., a speech recognition algorithm) to the audio data 234 captured via the audio sensor 204 of the emergency detection apparatus 102. Following block 310, control of the example program 300 of FIG. 3 proceeds to block 312.

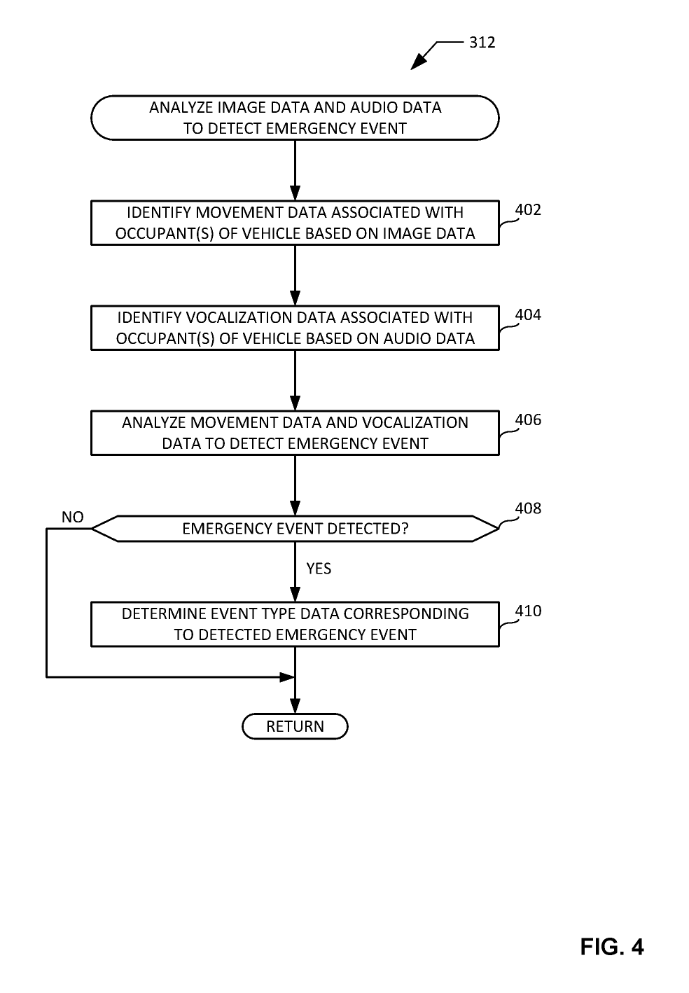

At block 312, the example event detector 212 of FIG. 2 analyzes the image data and the audio data to detect and/or predict an emergency event (block 312). An example process that may be used to implement block 312 of the example program 300 of FIG. 3 is described in greater detail below in connection with FIG. 4. Following block 312, control of the example program 300 of FIG. 3 proceeds to block 314.

At block 314, the example event detector 212 of FIG. 2 determines whether an emergency event has been detected and/or predicted (block 314). For example, the event detector 212 may determine at block 314 that an emergency event has been detected and/or predicted in connection with the analysis performed by the event detector 212 at block 312. If the event detector 212 determines at block 314 that no emergency event has been detected or predicted, control of the example program 300 of FIG. 3 returns to block 302. If the event detector 212 instead determines at block 314 that an emergency event has been detected or predicted, control of the example program 300 of FIG. 3 proceeds to block 316.

At block 316, the example notification generator 214 of FIG. 2 generates notification data associated with the detected and/or predicted emergency event (block 316). For example, the notification generator 214 may generate the notification data 252 based on the results of, and/or in response to the completion of, the analysis performed by the event detector 212 at block 312. In some examples, the notification data 252 may include the location data 236 (e.g., as identified at block 306), the vehicle identification data 238 (e.g., as identified at block 308), the occupant identification data 240 (e.g., as identified at block 310), and/or the event type data 250 (e.g., as may be determined in connection with block 312). In some examples, the notification data 252 may additionally include the emergency authority contact data 254 corresponding to contact information (e.g., a phone number, an electronic address such as an Internet protocol address, etc.) associated with one or more emergency authorit(ies) 256 (e.g., the emergency authority 112 of FIG. 1) to which the notification data 252 is to be transmitted. In some examples, the notification data 252 may additionally or alternatively include the third party service contact data 258 corresponding to contact information (e.g., a phone number, an electronic address such as an Internet protocol address, etc.) associated with one or more third party service(s) 260 (e.g., the third party service 114 of FIG. 1) to which the notification data 252 is to be transmitted. In some examples, the notification data 252 may additionally or alternatively include the subscriber contact data 262 corresponding to contact information (e.g., a phone number, an electronic address such as an Internet protocol address, etc.) associated with one or more subscriber machine(s) 264 (e.g., the first, second and/or third subscriber machine(s) 120, 124, 128 of FIG. 1) to which the notification data 252 is to be transmitted. Following block 316, control of the example program 300 of FIG. 3 proceeds to block 318.

At block 318, the example radio transmitter 226 of FIG. 2 transmits the generated notification data to one or more emergency authorit(ies), to one or more third party service(s), and/or to one or more subscriber machine(s) (block 318). For example, the radio transmitter 226 may transmit the notification data 252 from the emergency detection apparatus 102 of FIGS. 1 and/or 2 to any or all of the one or more emergency authorit(ies) 256 of FIG. 2, to any or all of the one or more third party service(s) 260 of FIG. 2, and/or to any or all of the one or more subscriber machine(s) 264 of FIG. 2. In some examples, the notification data 252 transmitted by the radio transmitter 226 at block 318 is communicated over a network (e.g., a cellular network and/or a wireless local area network) via the example cellular base station 116 and/or via the example wireless access point 118 of FIG. 1. Following block 318, control of the example program 300 of FIG. 3 proceeds to block 320.

At block 320, the emergency detection apparatus 102 of FIGS. 1 and/or 2 determines whether to continue detecting and/or predicting emergency events (block 320). For example, the emergency detection apparatus 102 may receive one or more signal(s), command(s) and or instruction(s) indicating that emergency event detection and/or prediction is not to continue. If the emergency detection apparatus 102 determines at block 320 that emergency event detection and/or prediction is to continue, control of the example program 300 of FIG. 3 returns to block 302. If the emergency detection apparatus 102 instead determines at block 320 that emergency event detection and/or prediction is not to continue, the example program 300 of FIG. 3 ends.

FIG. 4 is a flowchart representative of example machine readable instructions that may be executed to implement the example emergency detection apparatus 102 of FIGS. 1 and/or 2 to analyze image data and audio data to detect and/or predict emergency events. Example operations of blocks 402, 404, 406, 408 and 410 of FIG. 4 may be used to implement block 312 of FIG. 3.

The example program 312 of FIG. 4 begins when the example image analyzer 220 of FIG. 2 identifies movement data associated with the occupant(s) of the vehicle based on the image data (block 402). For example, the image analyzer 220 may analyze the image data 232 captured via the camera 202 of FIG. 2 to detect and/or predict one or more movement(s) associated with the occupant(s) of the vehicle 104 of FIG. 1. In some examples, the image analyzer 220 may predict, detect, identify and/or determine whether the image data 232 includes any movement(s) associated with the occupant(s) of the vehicle 104 that is/are indicative of the development or occurrence of an emergency event involving the occupant(s) and/or the vehicle 104. Such movement(s) may include, for example, the ejection or removal of an occupant from the vehicle 104, the entry of an occupant into the vehicle 104, a body position (e.g., posture, attitude, pose, bracing position, defensive position, etc.) of an occupant of the vehicle 104, a facial expression of an occupant of the vehicle 104, etc., as further described above. Following block 402, control of the example program 312 of FIG. 4 proceeds to block 404.

At block 404, the example audio analyzer 222 of FIG. 2 identifies vocalization data associated with the occupant(s) of the vehicle based on the audio data (block 404). For example, the audio analyzer 222 may analyze the audio data 234 captured via the audio sensor 204 of FIG. 2 to detect and/or predict one or more vocalization(s) associated with the occupant(s) of the vehicle 104 of FIG. 1. In some examples, the audio analyzer 222 may predict, detect, identify and/or determine whether the audio data 234 includes any vocalization(s) associated with the occupant(s) of the vehicle 104 that is/are indicative of the development or occurrence of an emergency event involving the occupant(s) and/or the vehicle 104. Such vocalization(s) may include, for example, a pattern (e.g., a series) of words spoken by an occupant, a pattern (e.g., a series) of sounds uttered by an occupant, a speech characteristic (e.g., intonation, articulation, pronunciation, cessation, tone, pitch, rate, rhythm, etc.) associated with words spoken by an occupant, a speech characteristic (e.g., intonation, articulation, pronunciation, cessation, tone, pitch, rate, rhythm, etc.) associated with sounds uttered by an occupant, etc., as further described above. Following block 404, control of the example program 312 of FIG. 4 proceeds to block 406.

At block 406, the example event detector 212 of FIG. 2 analyzes the movement data and the vocalization data to detect and/or predict an emergency event (block 406). For example, the event detector 212 of FIG. 2 may analyze the movement data 244 predicted, detected, identified and/or determined by the image analyzer 220 of FIG. 2 in relation to the image data 232 captured via the camera 202 of FIG. 2, and may further analyze the vocalization data 246 predicted, detected, identified and/or determined by the audio analyzer 222 of FIG. 2 in relation to the audio data 234 captured via the audio sensor 204 of FIG. 2. Following block 406, control of the example program 312 of FIG. 4 proceeds to block 408.

At block 408, the example event detector 212 of FIG. 2 determines whether an emergency event has been detected and/or predicted (block 408). For example, the event detector 212 may determine at block 408 that an emergency event has been detected and/or predicted in connection with the analysis performed by the event detector 212 at block 406. If the event detector 212 determines at block 408 that no emergency event has been detected or predicted, control of the example program 312 of FIG. 4 returns to a function call such as block 312 of the example program 300 of FIG. 3. If the event detector 212 instead determines at block 408 that an emergency event has been detected or predicted, control of the example program 312 of FIG. 4 proceeds to block 410.

At block 410, the example event classifier 224 of FIG. 2 determines event type data corresponding to the detected and/or predicted emergency event (block 410). For example, the event classifier 224 may predict, detect, identify and/or determine whether the movement data 244 and/or the vocalization data 246 associated with the detected and/or predicted emergency event is/are indicative of one or more event type(s) from among a library or database of classified emergency events. In some examples, the event classifier 224 of FIG. 2 may compare the movement data 244 and/or the vocalization data 246 associated with the detected and/or predicted emergency event to the event classification data 248 that includes and/or is indicative of different types of classified emergency events. If the comparison performed by the event classifier 224 of FIG. 2 results in one or more matches in relation to the event classification data 248, the event classifier 224 identifies the matching event type(s) as the event type data 250, and assigns or otherwise associates the matching event type(s) and/or the event type data 250 to or with the detected and/or predicted emergency event. Following block 410, control of the example program 312 of FIG. 4 returns to a function call such as block 312 of the example program 300 of FIG. 3.

FIG. 5 is a block diagram of an example processor platform 500 structured to execute the example instructions 300 of FIGS. 3 and/or 4 to implement the example emergency detection apparatus 102 of FIGS. 1 and/or 2. The processor platform 500 can be, for example, an in-vehicle computer, a laptop computer, a self-learning machine (e.g., a neural network), a mobile device (e.g., a cell phone, a smart phone, a tablet), a personal digital assistant (PDA), or any other type of computing device.

The processor platform 500 of the illustrated example includes a processor 502. The processor 502 of the illustrated example is hardware. For example, the processor 502 can be implemented by one or more integrated circuits, logic circuits, microprocessors, GPUs, DSPs, or controllers from any desired family or manufacturer. The hardware processor may be a semiconductor based (e.g., silicon based) device. In this example, the processor 502 implements the example vehicle identifier 208, the example occupant identifier 210, the example event detector 212, the example image analyzer 220, the example audio analyzer 222, and the example event classifier 224 of FIG. 2. The processor 502 is in communication with the example GPS receiver 206 of FIG. 2 via a bus 506. The bus 506 may be implemented via the example communication bus 230 of FIG. 2.

The processor 502 of the illustrated example includes a local memory 504 (e.g., a cache). The processor 502 of the illustrated example is in communication with a main memory including a volatile memory 508 and a non-volatile memory 510 via the bus 506. The volatile memory 508 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 510 may be implemented by flash memory and/or any other desired type of memory device. Access to the main memory 508, 510 is controlled by a memory controller.

The processor platform 500 of the illustrated example also includes one or more mass storage device(s) 512 for storing software and/or data. Examples of such mass storage devices 512 include floppy disk drives, hard drive disks, compact disk drives, Blu-ray disk drives, redundant array of independent disks (RAID) systems, and digital versatile disk (DVD) drives. In the illustrated example of FIG. 5, the mass storage device(s) 512 include(s) the example memory 218 of FIG. 2.

The processor platform 500 of the illustrated example also includes a user interface circuit 514. The user interface circuit 514 may be implemented by any type of interface standard, such as an Ethernet interface, a universal serial bus (USB), a Bluetooth® interface, a near field communication (NFC) interface, and/or a PCI express interface.

In the illustrated example, one or more input device(s) 516 are connected to the user interface circuit 514. The input device(s) 516 permit(s) a user to enter data and/or commands into the processor 502. The input device(s) can be implemented by, for example, an audio sensor, a microphone, a camera (still or video), a keyboard, a button, a mouse, a touchscreen, a track-pad, a trackball, isopoint and/or a voice recognition system. In the illustrated example of FIG. 5, the input devices 516 include the example camera 202 and the example audio sensor 204 of FIG. 2.

One or more output device(s) 518 are also connected to the user interface circuit 514 of the illustrated example. The output device(s) 518 can be implemented, for example, by display devices (e.g., a light emitting diode (LED), an organic light emitting diode (OLED), a liquid crystal display (LCD), a cathode ray tube display (CRT), an in-plane switching (IPS) display, a touchscreen, etc.), a tactile output device, and/or speaker. The user interface circuit 514 of the illustrated example, thus, typically includes a graphics driver card, a graphics driver chip and/or a graphics driver processor.

The processor platform 500 of the illustrated example also includes a network interface circuit 520. The network interface circuit 520 may be implemented by any type of interface standard, such as an Ethernet interface, a universal serial bus (USB), a Bluetooth® interface, a near field communication (NFC) interface, and/or a PCI express interface. In the illustrated example, the network interface circuit 520 includes the example radio transmitter 226 and the example radio receiver 228 of FIG. 2 to facilitate the exchange of data and/or signals with external machines (e.g., the emergency authorit(ies) 256 of FIG. 2, the third party service(s) 260 of FIG. 2, the subscriber machine(s) 264 of FIG. 2, etc.) via a network 522 (e.g., a cellular network, a wireless local area network (WLAN), etc.).

The machine executable instructions 300 of FIGS. 3 and/or 4 may be stored in the mass storage device(s) 512, in the volatile memory 508, in the non-volatile memory 510, and/or on a removable non-transitory computer readable storage medium such as a CD or DVD.

From the foregoing, it will be appreciated that methods and apparatus have been disclosed for detecting and/or predicting emergency events based on vehicle occupant behavior data. Unlike the known accident detection systems and speech recognition systems, the methods and apparatus disclosed herein advantageously implement an artificial intelligence framework to automatically detect and/or predict one or more emergency event(s) in real time (or near real time) based on behavior data associated with one or more occupant(s) of a vehicle. In some examples, an emergency event is automatically detected and/or predicted based on one or more movement(s) of the occupant(s) of the vehicle, with such movement(s) being identified by the artificial intelligence framework in real time (or near real time) by analyzing captured image data obtained via one or more camera(s) of the vehicle. Some examples additionally or alternatively automatically detect and/or predict an emergency event based on one or more vocalization(s) of the occupant(s) of the vehicle, with such vocalization(s) being identified by the artificial intelligence framework in real time (or near real time) by analyzing captured audio data obtained via one or more audio sensor(s) of the vehicle.

In response to automatically detecting and/or predicting an emergency event, example methods and apparatus disclosed herein automatically generate a notification of the emergency event, and automatically transmit the generated notification to an emergency authority or a third party service supporting contact to such an authority. In some examples, the notification may include location data identifying the location of the vehicle. In some examples, the notification may further include event type data identifying the type of emergency that occurred, is about to occur, and/or is occurring. In some examples, the notification may further include vehicle identification data identifying the vehicle. In some examples, the notification may further include occupant identification data identifying the occupant(s) of the vehicle.

As a result of the performance of automated emergency event detection and/or prediction in real time (or near real time) via an artificial intelligence framework as disclosed herein, automated notification generation and notification transmission capabilities disclosed herein can advantageously be implemented and/or executed while an emergency event is still developing (e.g., prior to the event occurring), when the emergency event is about to occur, and/or while the emergency event is occurring. Accordingly, examples disclosed herein can advantageously notify an emergency authority (or a third party service supporting contact to such an authority) of an emergency event in real time (or near real time) before and/or while it is occurring, as opposed to after the emergency event has already occurred.

Some example methods and apparatus disclosed herein may additionally or alternatively automatically transmit the generated notification to one or more subscriber device(s) which may be associated with one or more other vehicle(s). In some examples, one or more of the notified other vehicle(s) may be located at a distance from the vehicle associated with the emergency event that is less than a distance between the notified emergency authority and the vehicle. In such examples, one or more of the notified other vehicle(s) may be able to reach the vehicle more quickly than would be the case for an emergency vehicle dispatched by the notified emergency authority. One or more of the notified other vehicle(s) may accordingly be able to assist in resolving the emergency event (e.g., administering cardiopulmonary resuscitation or other medical assistance, tracking a vehicle or an individual traveling with a kidnapped child, etc.).

In some examples, an apparatus is disclosed. In some disclosed examples, the apparatus comprises at least one of a camera and an audio sensor, and further comprises an event detector, a notification generator, and a radio transmitter. In some disclosed examples, the camera is to capture image data associated with an occupant inside of a vehicle. In some disclosed examples, the audio sensor is to capture audio data associated with the occupant inside of the vehicle. In some disclosed examples, the event detector is to at least one of predict or detect an emergency event based on the at least one of the image data and the audio data. In some disclosed examples, the notification generator is to generate notification data in response to an output of the event detector. In some disclosed examples, the radio transmitter is to transmit the notification data.

In some disclosed examples, the event detector includes an image analyzer, an audio analyzer, and an event classifier. In some disclosed examples, the image analyzer is to detect movement data based on the image data. In some disclosed examples, the movement data is associated with the occupant of the vehicle. In some disclosed examples, the audio analyzer is to detect vocalization data based on the audio data. In some disclosed examples, the vocalization data is associated with the occupant of the vehicle. In some disclosed examples, the event detector is to at least one of predict or detect the emergency event based on the movement data and the vocalization data. In some disclosed examples, the event classifier is to determine event type data corresponding to the emergency event.

In some disclosed examples, the event classifier is to determine the event type data by comparing the movement data and the vocalization data to event classification data. In some disclosed examples, the event classification data is indicative of different types of classified emergency events.

In some disclosed examples, the notification data includes location data associated with a location of the vehicle. In some disclosed examples, the notification data further includes event type data associated with the emergency event. In some disclosed examples, the notification data further includes vehicle identification data associated with the vehicle. In some disclosed examples, the notification data further includes occupant identification data associated with the occupant of the vehicle.

In some disclosed examples, the radio transmitter is to transmit the notification data to at least one of an emergency authority, a third party service for contacting an emergency authority, or a subscriber machine associated with another vehicle.

In some examples, a non-transitory computer-readable storage medium comprising instructions is disclosed. In some disclosed examples, the instructions, when executed, cause one or more processors to access at least one of: image data captured via a camera, the image data associated with an inside of a vehicle; and audio data captured via an audio sensor, the audio data associated with the inside of the vehicle. In some disclosed examples, the instructions, when executed, cause the one or more processors to at least one of predict or detect an emergency event based on the at least one of the image data and the audio data. In some disclosed examples, the instructions, when executed, cause the one or more processors to generate notification data in response to the at least one of the prediction or detection. In some disclosed examples, the instructions, when executed, cause the one or more processors to initiate transmission of the notification data via a radio transmitter.

In some disclosed examples, the instructions, when executed, further cause the one or more processors to detect movement data based on the image data. In some disclosed examples, the movement data is associated with an occupant inside of the vehicle. In some disclosed examples, the instructions, when executed, further cause the one or more processors to detect vocalization data based on the audio data. In some disclosed examples, the vocalization data is associated with the occupant inside of the vehicle. In some disclosed examples, the at least one of the prediction or detection of the emergency event is based on the movement data and the vocalization data. In some disclosed examples, the instructions, when executed, further cause the one or more processors to determine event type data corresponding to the emergency event.

In some disclosed examples, the instructions, when executed, further cause the one or more processors to determine the event type data by comparing the movement data and the vocalization data to event classification data. In some disclosed examples, the event classification data is indicative of different types of classified emergency events.

In some disclosed examples, the notification data includes location data associated with a location of the vehicle. In some disclosed examples, the notification data further includes event type data associated with the emergency event. In some disclosed examples, the notification data further includes vehicle identification data associated with the vehicle. In some disclosed examples, the notification data further includes occupant identification data associated with an occupant inside of the vehicle.

In some disclosed examples, the instructions, when executed, cause the one or more processors to initiate transmission of the notification data, via the radio transmitter, to at least one of an emergency authority, a third party service for contacting an emergency authority, or a subscriber machine associated with another vehicle.

In some examples, a method is disclosed. In some disclosed examples, the method comprises accessing at least one of: image data captured via a camera, the image data associated with an inside of a vehicle; and audio data captured via an audio sensor, the audio data associated with the inside of the vehicle. In some disclosed examples, the method further includes at least one of predicting or detecting, by executing a computer-readable instruction with one or more processors, an emergency event based on the at least one of the image data and the audio data. In some disclosed examples, the method further includes generating, by executing a computer-readable instruction with the one or more processors, notification data in response to the at least one of the predicting or detecting. In some disclosed examples, the method further includes transmitting the notification data via a radio transmitter.

In some disclosed examples, the method further includes detecting, by executing a computer-readable instruction with the one or more processors, movement data based on the image data. In some disclosed examples, the movement data is associated with an occupant inside of the vehicle. In some disclosed examples, the method further includes detecting, by executing a computer-readable instruction with the one or more processors, vocalization data based on the audio data. In some disclosed examples, the vocalization data is associated with the occupant inside of the vehicle. In some disclosed examples, the at least one of the predicting or detecting of the emergency event is based on the movement data and the vocalization data. In some disclosed examples, the method further includes determining, by executing a computer-readable instruction with the one or more processors, event type data corresponding to the emergency event.

In some disclosed examples, the determining of the event type data includes comparing the movement data and the vocalization data to event classification data. In some disclosed examples, the event classification data is indicative of different types of classified emergency events

In some disclosed examples, the notification data includes location data associated with a location of the vehicle. In some disclosed examples, the notification data further includes event type data associated with the emergency event. In some disclosed examples, the notification data further includes vehicle identification data associated with the vehicle. In some disclosed examples, the notification data further includes occupant identification data associated with an occupant inside of the vehicle.

In some disclosed examples, the transmitting the notification data includes transmitting the notification data, via the radio transmitter, to at least one of an emergency authority, a third party service for contacting an emergency authority, or a subscriber machine associated with another vehicle.

In some examples, an apparatus is disclosed. In some disclosed examples, the apparatus comprises at least one of: image capturing means for capturing image data associated with an occupant inside of a vehicle; and audio capturing means for capturing audio data associated with the occupant inside of the vehicle. In some disclosed examples, the apparatus further includes event detecting means for at least one of predicting or detecting an emergency event based on the at least one of the image data and the audio data. In some disclosed examples, the apparatus further includes notification generating means for generating notification data in response to an output of the event detecting means. In some disclosed examples, the apparatus further includes transmitting means for transmitting the notification data.

In some disclosed examples, the event detecting means includes image analyzing means for detecting movement data based on the image data. In some disclosed examples, the movement data is associated with the occupant of the vehicle. In some disclosed examples, the event detecting means further includes audio analyzing means for detecting vocalization data based on the audio data. In some disclosed examples, the vocalization data is associated with the occupant of the vehicle. In some disclosed examples, the event detecting means is to at least one of predict or detect the emergency event based on the movement data and the vocalization data. In some disclosed examples, the event detecting means further includes event classifying means for determining event type data corresponding to the emergency event.

In some disclosed examples, the event classifying means is to determine the event type data by comparing the movement data and the vocalization data to event classification data. In some disclosed example, the event classification data is indicative of different types of classified emergency events.

In some disclosed examples, the notification data includes location data associated with a location of the vehicle. In some disclosed examples, the notification data further includes event type data associated with the emergency event. In some disclosed examples, the notification data further includes vehicle identification data associated with the vehicle. In some disclosed examples, the notification data further includes occupant identification data associated with the occupant of the vehicle.

In some disclosed examples, the transmitting means is for transmitting the notification data to at least one of an emergency authority, a third party service for contacting an emergency authority, or a subscriber machine associated with another vehicle.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. An apparatus comprising:
at least one of:
a camera to capture image data associated with an occupant inside of a vehicle; and
an audio sensor to capture audio data associated with the occupant inside of the vehicle;
an event detector to at least one of predict or detect an emergency event based on the at least one of the image data and the audio data;
a notification generator to generate notification data in response to an output of the event detector; and
a radio transmitter to transmit the notification data.

2. An apparatus as defined in claim 1, wherein the event detector includes:
an image analyzer to detect movement data based on the image data, the movement data associated with the occupant of the vehicle;
an audio analyzer to detect vocalization data based on the audio data, the vocalization data associated with the occupant of the vehicle, the event detector to at least one of predict or detect the emergency event based on the movement data and the vocalization data; and
an event classifier to determine event type data corresponding to the emergency event.

3. An apparatus as defined in claim 2, wherein the event classifier is to determine the event type data by comparing the movement data and the vocalization data to event classification data, the event classification data being indicative of different types of classified emergency events.

4. An apparatus as defined in claim 1, wherein the notification data includes location data associated with a location of the vehicle.

5. An apparatus as defined in claim 4, wherein the notification data further includes event type data associated with the emergency event.

6. An apparatus as defined in claim 4, wherein the notification data further includes vehicle identification data associated with the vehicle.

7. An apparatus as defined in claim 4, wherein the notification data further includes occupant identification data associated with the occupant of the vehicle.

8. An apparatus as defined in claim 1, wherein the radio transmitter is to transmit the notification data to at least one of:
an emergency authority;
a third party service for contacting an emergency authority; or
a subscriber machine associated with another vehicle.

9. A non-transitory computer-readable storage medium comprising instructions that, when executed, cause one or more processors to at least:
access at least one of:
image data captured via a camera, the image data associated with an inside of a vehicle; and
audio data captured via an audio sensor, the audio data associated with the inside of the vehicle;
at least one of predict or detect an emergency event based on the at least one of the image data and the audio data;
generate notification data in response to the at least one of the prediction or detection; and
initiate transmission of the notification data via a radio transmitter.

10. A non-transitory computer-readable storage medium as defined in claim 9, wherein the instructions, when executed, further cause the one or more processors to:
detect movement data based on the image data, the movement data associated with an occupant inside of the vehicle;
detect vocalization data based on the audio data, the vocalization data associated with the occupant inside of the vehicle, the at least one of the prediction or detection of the emergency event being based on the movement data and the vocalization data; and
determine event type data corresponding to the emergency event.

11. A non-transitory computer-readable storage medium as defined in claim 10, wherein the instructions, when executed, further cause the one or more processors to determine the event type data by comparing the movement data and the vocalization data to event classification data, the event classification data being indicative of different types of classified emergency events.

12. A non-transitory computer-readable storage medium as defined in claim 9, wherein the notification data includes location data associated with a location of the vehicle.

13. A non-transitory computer-readable storage medium as defined in claim 12, wherein the notification data further includes at least one of event type data associated with the emergency event, vehicle identification data associated with the vehicle, or occupant identification data associated with an occupant inside of the vehicle.

14. A non-transitory computer-readable storage medium as defined in claim 9, wherein the instructions, when executed, further cause the one or more processors to initiate transmission of the notification data, via the radio transmitter, to at least one of:
an emergency authority;
a third party service for contacting an emergency authority; or
a subscriber machine associated with another vehicle.

15. A method comprising:
accessing at least one of:
image data captured via a camera, the image data associated with an inside of a vehicle; and
audio data captured via an audio sensor, the audio data associated with the inside of the vehicle;
at least one of predicting or detecting, by executing a computer-readable instruction with one or more processors, an emergency event based on the at least one of the image data and the audio data;
generating, by executing a computer-readable instruction with the one or more processors, notification data in response to the at least one of the predicting or detecting; and
transmitting the notification data via a radio transmitter.

16. A method as defined in claim 15, further including:
detecting, by executing a computer-readable instruction with the one or more processors, movement data based on the image data, the movement data associated with an occupant inside of the vehicle;
detecting, by executing a computer-readable instruction with the one or more processors, vocalization data based on the audio data, the vocalization data associated with the occupant inside of the vehicle, the at least one of the predicting or detecting of the emergency event being based on the movement data and the vocalization data; and
determining, by executing a computer-readable instruction with the one or more processors, event type data corresponding to the emergency event.

17. A method as defined in claim 16, wherein the determining of the event type data includes comparing the movement data and the vocalization data to event classification data, the event classification data being indicative of different types of classified emergency events.

18. A method as defined in claim 15, wherein the notification data includes location data associated with a location of the vehicle.

19. A method as defined in claim 18, wherein the notification data further includes at least one of event type data associated with the emergency event, vehicle identification data associated with the vehicle, or occupant identification data associated with an occupant inside of the vehicle.

20. A method as defined in claim 15, wherein transmitting the notification data includes transmitting the notification data, via the radio transmitter, to at least one of:
an emergency authority;
a third party service for contacting an emergency authority; or
a subscriber machine associated with another vehicle.
